(19) United States
(12) Patent Application Publication
(10) Pub. No.: US 2009/0072623 A1
(43) Pub. Date: Mar. 19, 2009

(54) UNINTERRUPTIBLE POWER SUPPLY SYSTEM AND CONTROLLING METHOD THEREOF

(75) Inventor: Jen-Chuan Liao, Taoyuan Hsien (TW)

Correspondence Address: KIRTON AND MCCONKIE, 60 EAST SOUTH TEMPLE,, SUITE 1800, SALT LAKE CITY, UT, 84111, US

(73) Assignee: DELTA ELECTRONICS, INC., Taoyuan Hsien (TW)

(21) Appl. No.: 11/969,565

(22) Filed: Jan. 4, 2008

(30) Foreign Application Priority Data
Sep. 19, 2007 (TW) 096134982

(51) Int. Cl. H02J 9/00

(52) U.S. Cl. 307/65

(57) ABSTRACT

A controlling method of uninterruptible power supply system comprising a first UPS and a second UPS for continuously providing power to a load is disclosed. The controlling method includes the steps of (a) determining if the first UPS is normal; (b) providing power to the load via the first UPS when the first UPS is normal and determining if the second UPS is normal when the first UPS is abnormal; and (c) providing power to the load through the second UPS when the second UPS is normal and providing the power to the load through a bypass route when the first UPS and the second UPS are both abnormal.

### FIELD OF THE INVENTION

The present invention is related to a power supply system and the controlling method thereof, and more particularly to an uninterruptible power supply system and the controlling method thereof.

### BACKGROUND OF THE INVENTION

With the rapid progress of information technology and the rapid development of the high-tech industry, most of the sophisticated electronic instruments and equipments rely on high-quality power supply to maintain a normal operation. Among a variety of power-supplying solutions, uninterruptible power supply can ensure a nonstop and high-quality power supply. Therefore, uninterruptible power supply has become the best solution for providing a high-quality power supply. In order to promote the reliability of the uninterruptible power supply, two or more uninterruptible power supplies would be employed and a static transfer switch would be used to allow one of the uninterruptible power supplies to serve as a main uninterruptible power supply for supplying power to a load, so that the power supply of the uninterruptible power supply system will not be interrupted as a result of the malfunction of a single uninterruptible power supply.

Referring to FIG. 1, the circuitry of a conventional uninterruptible power supply system is shown. As shown in FIG. 1, the uninterruptible power supply system 1 includes a first uninterruptible power supply UPS1, a second uninterruptible power supply UPS2, and a system static transfer switch 10, wherein an input voltage Vin is connected to the power input terminal of the first uninterruptible power supply UPS1 and the power input terminal of the second uninterruptible power supply UPS2, and the power output terminal of the first uninterruptible power supply UPS1 and the power output terminal of the second uninterruptible power supply UPS2 are respectively connected to a first power input terminal Input1 and a second power input terminal Input2 of the system static transfer switch 10. Therefore, one of the uninterruptible power supplies is allowed to power the load 13 through the system static transfer switch 10.

In addition, the first uninterruptible power supply UPS1 includes an AC/DC converter 111, a charger circuit 112, a battery module 113, a DC/DC converter 114, an inverter 115, a controller 116, a local static transfer switch 117, a bypass route 118, and a communication port 119. Likewise, the second uninterruptible power supply UPS2 includes an AC/DC converter 121, a charger circuit 122, a battery module 123, a DC/DC converter 124, an inverter 125, a controller 126, a local static transfer switch 127, a bypass route 128, and a communication port 129. The function and association of the elements of the uninterruptible power supply system 1 and the controlling method thereof are described as follows.

When the first uninterruptible power supply UPS1 is working normally and the input voltage Vin is normal, the controller 116 of the first uninterruptible power supply UPS1 manipulates the AC/DC converter 111 to convert the input voltage Vin into a DC voltage having a predetermined voltage level, and this DC voltage is provided for the charger circuit 112 and the inverter 115. In the meantime, the controller 116 manipulates the inverter 115 to convert this DC voltage into a standard and reliable AC voltage, and the output voltage V1 of the inverter 115 is outputted to the first power input terminal Input1 of the system static transfer switch 10 through the local static transfer switch 117 of the first uninterruptible power supply UPS1. Therefore, the AC voltage outputted from the first uninterruptible power supply UPS1 is provided for the load 13. Under this condition, the load 13 is powered by the first uninterruptible power supply UPS1, and the charger circuit 112 will convert the DC voltage outputted from the AC/DC converter 111 into a DC voltage tailored to charge the battery module 113, thereby charging the battery module 113.

Even if the input voltage Vin is abnormal, for example, when the input voltage Vin is interrupted or has an insufficient voltage level, the controller 116 will manipulate the DC/DC converter 114 to convert the voltage of the battery module 113 into a DC voltage requested by the inverter 115, so that the inverter 115 converts this DC voltage into an AC voltage. The output voltage V1 of the inverter 115 is outputted to the first power input terminal Input1 of the system static transfer switch 10 through the local static transfer switch 117, so as to power the load 13 with this standard and reliable AC power through the system static transfer switch 10. Under this condition, the load 13 is powered by the first uninterruptible power supply UPS1 as well. Therefore, the power provided for the load 13 is supplied by the battery module 113 of the first uninterruptible power supply UPS1, wherein the battery module 113 is composed of a plurality of batteries, and the time for the battery module 113 to sustain power supply depends on the number of batteries of the battery module 113.

Therefore, no matter whether the input voltage Vin is normal or not, the first uninterruptible power supply UPS1 will continuously output standard and reliable AC power to the first power input terminal Input1 of the system static transfer switch 10, and then the system static transfer switch 10 will provide this standard and reliable AC power for the load 13. Under this condition, the operation of the second uninterruptible power supply UPS2 is similar to that of the first uninterruptible power supply UPS1. No matter whether the input voltage Vin is normal or not, the second uninterruptible power supply UPS2 will output standard and reliable AC power to the second power input terminal Input2 of the system static transfer switch 10 as well. Under this condition, a phase lock controller 14 is activated to regulate the output voltage Vo1 of the first uninterruptible power supply UPS1 and the output voltage Vo2 of the second uninterruptible power supply UPS2 through the communication port 119 of the first uninterruptible power supply UPS1 and the communication port 129 of the second uninterruptible power supply UPS2. In this way, the output voltage Vo1 has the same voltage level, frequency and phase with the output voltage Vo2. When the first uninterruptible power supply UPS1 is malfunctioned, the system static transfer switch 10 will provide the standard and reliable AC power outputted from the second uninterruptible power supply UPS2 for the load 13. Under this condition, the second uninterruptible power supply UPS2 is responsible for powering the load 13 instead of the first uninterruptible power supply UPS1.

Nevertheless, the power delivery of the conventional uninterruptible power supply system 1 has to pass through two local static transfer switches, which would reduce the efficiency of the uninterruptible power supply system 1. What is worse, the utility fee of the uninterruptible power supply system 1 would increase. Besides, if one of the local static transfer switches is malfunctioned, the uninterruptible power supply system 1 will halt its operation. This would deteriorate the reliability of the uninterruptible power supply system 1. Furthermore, in order to allow two uninterruptible power supplies to output an AC voltage with the same phase, an additional phase lock controller 14 is necessary. This would also increase the cost of the uninterruptible power supply system 1.

Hence, it is essential to develop an uninterruptible power supply system and the controlling method thereof for removing the drawbacks encountered by the prior art.

### SUMMARY OF THE INVENTION

An object of the present invention is to provide an uninterruptible power supply system and the controlling method thereof. The inventive uninterruptible power supply system utilizes the switch circuit within each uninterruptible power supply to determine whether the uninterruptible power supply is to power the load. Therefore, the power delivery of the uninterruptible power supply system according to the present invention does not need to pass through two switches, thereby reducing power loss and enhancing efficiency. Moreover, the utility fee of the uninterruptible power supply system can be lowered. In addition, the power delivery of the uninterruptible power supply system according to the present invention does not need to pass through the system static transfer switch, thereby promoting the reliability of the uninterruptible power supply system. More advantageously, the uninterruptible power supply system according to the present invention utilizes the controller within each uninterruptible power supply instead of a phase lock controller for synchronizing the phases of the output AC voltages of the uninterruptible power supply system, thereby reducing the cost of the uninterruptible power supply system.

To this end, an aspect of the present invention is to provide a controlling method for an uninterruptible power supply system. The controlling method enables the uninterruptible power supply system to power a load continuously. The uninterruptible power supply system includes a first uninterruptible power supply and a second uninterruptible power supply, wherein each uninterruptible power supply includes a power input terminal, a power output terminal, a communication port, and a bypass route. The power input terminal, power output terminal and communication port of the first uninterruptible power supply are respectively connected with the power input terminal, power output terminal and communication port of the second uninterruptible power supply, and the power output terminals are connected to a load. The controlling method of the uninterruptible power supply system includes the steps of: (a) determining if the first uninterruptible power supply is normal; (b) if it is determined that the first uninterruptible power supply is normal, powering the load by the first uninterruptible power supply, and if it is determined that the first uninterruptible power supply is abnormal, determining if the second uninterruptible power supply is normal; and (c) if it is determined that the second uninterruptible power supply is normal, powering the load by the second uninterruptible power supply, and if it is determined that the second uninterruptible power supply is abnormal, powering the load with an input voltage through the bypass route of the first uninterruptible power supply and the bypass route of the second uninterruptible power supply.

Another aspect of the present invention is to provide a controlling method for an uninterruptible power supply system. The controlling method enables the uninterruptible power supply system to power a load continuously. The uninterruptible power supply system includes a plurality of uninterruptible power supplies that are divided into a plurality of groups, wherein each uninterruptible power supply includes a power input terminal, a power output terminal, a communication port and a bypass route. The power input terminal, power output terminal and communication port of each uninterruptible power supply are respectively connected with the power input terminal, power output terminal and communication port of a corresponding uninterruptible power supply, and the power output terminals are connected to a load. The controlling method of the uninterruptible power supply system includes the steps of: (a) determining if each uninterruptible power supply of a first uninterruptible power supply group is normal; (b) if it is determined that each uninterruptible power supply of a first uninterruptible power supply group is normal, powering the load by the first uninterruptible power supply group, and if it is determined that at least one of the first uninterruptible power supply group is abnormal, determining if each uninterruptible power supply of the next uninterruptible power supply group is normal; (c) if it is determined that each uninterruptible power supply of the next uninterruptible power supply group is normal, powering the load by the next uninterruptible power supply group, and if it is determined that at least one of the next uninterruptible power supply group is abnormal, determining if each uninterruptible power supply group has been determined; and (d) if all of the uninterruptible power supply groups have been checked, powering the load with an input voltage through the bypass routes of the plurality of uninterruptible power supplies.

Another yet aspect of the present invention is to provide an uninterruptible power supply system for powering a load. The uninterruptible power supply system at least includes a first uninterruptible power supply and a second uninterruptible power supply. Each of the uninterruptible power supplies includes a battery module for storing power; an AC/DC converter for converting a first AC voltage received from a power input terminal into a DC voltage; a charger circuit connected to the AC/DC converter and the battery module for charging the battery module; an inverter connected to the AC/DC converter and the charger circuit for converting the DC voltage into a second AC voltage; a bypass route connected to the power input terminal; a switch circuit connected to the bypass route, the inverter and a power output terminal; a controller connected to the power input terminal, the AC/DC converter, the charger circuit and the inverter for controlling the operation of the uninterruptible power supply; a communication port connected to the controller; and a switch controller connected to the switch circuit, the bypass route and the inverter for performing a controlling method that includes the steps of: (a) determining if the first uninterruptible power supply is normal; (b) if it is determined that the first uninterruptible power supply is normal, powering the load by the first uninterruptible power supply, and if it is determined that the first uninterruptible power supply is abnormal, determining if the second uninterruptible power supply is normal; and (c) if it is determined that the second uninterruptible power supply is normal, powering the load by the second uninterruptible power supply, and if it is determined that the second uninterruptible power supply is abnormal, powering the load with an input voltage through the bypass route of the first uninterruptible power supply and the bypass route of the second uninterruptible power supply. Also, the power input terminal, power output terminal and communication port of the first uninterruptible power supply are connected to the power input terminal, power output terminal and communication port of the second uninterruptible power supply, respectively.

Now the foregoing and other features and advantages of the present invention will be best understood through the following descriptions with reference to the accompanying drawings, wherein:

### BRIEF DESCRIPTION OF THE DRAWINGS

FIG. 1 is a circuit diagram showing a conventional uninterruptible power supply system;

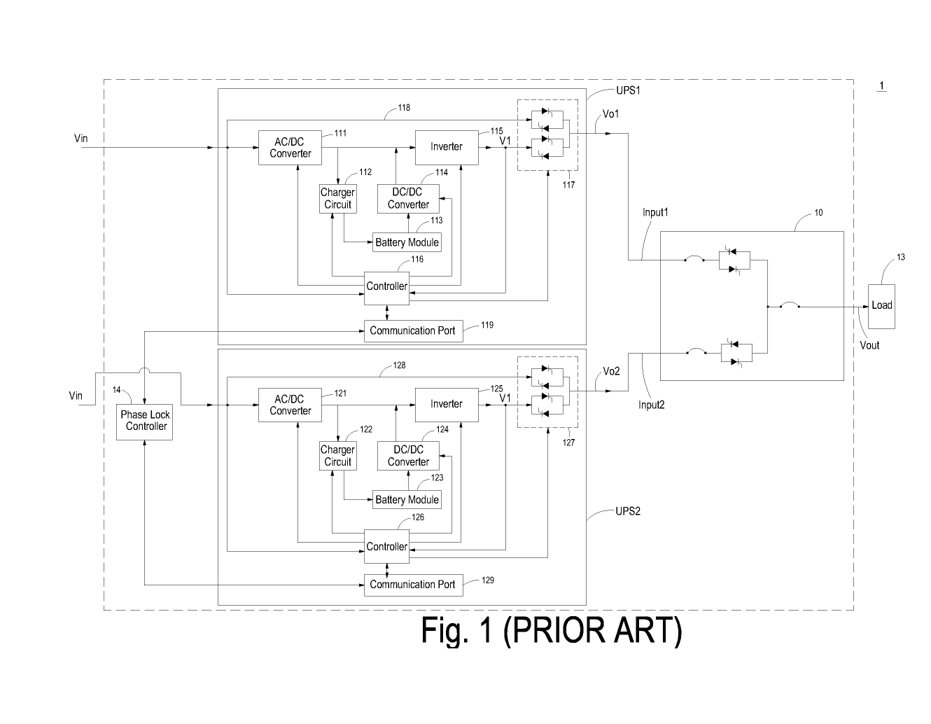

FIG. 2 is a circuit diagram showing an uninterruptible power supply system according to a preferred embodiment of the present invention; and

FIG. 3 is a flowchart illustrating the controlling method for use by the uninterruptible power supply system of the present invention.

### DETAILED DESCRIPTION OF THE PREFERRED EMBODIMENT

A preferred embodiment embodying the features and advantages of the present invention will be expounded in following paragraphs of descriptions. It is to be realized that the present invention is allowed to have various modification in different respects, all of which are without departing from the scope of the present invention, and the description herein and the drawings are to be taken as illustrative in nature, but not to be taken as limitative.

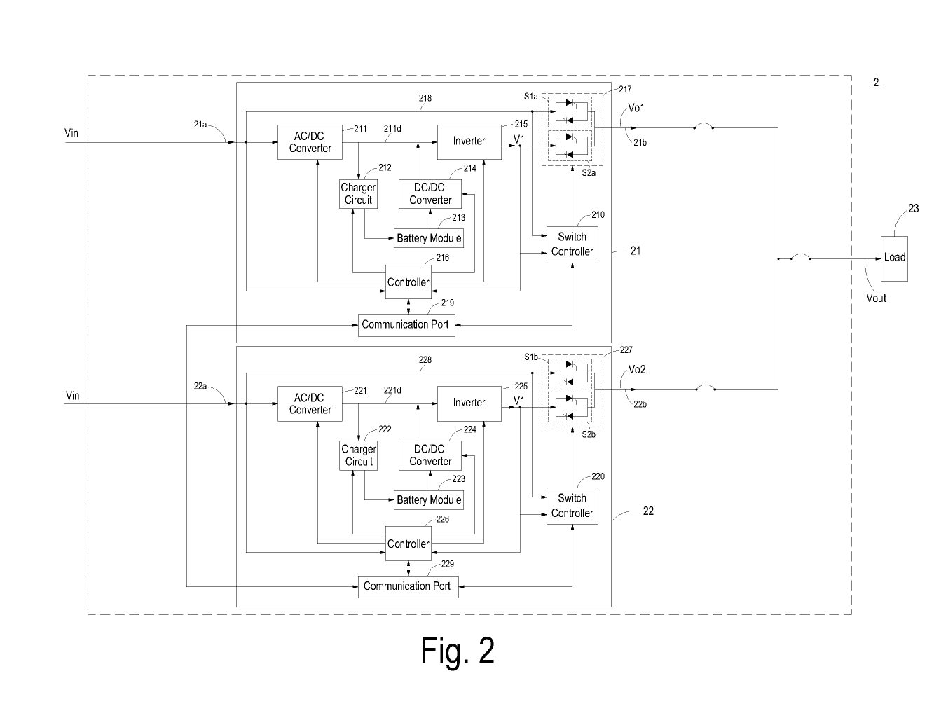

The uninterruptible power supply system according to the present invention includes a plurality of uninterruptible power supplies that are divided into a plurality of groups. In the following example, the uninterruptible power supply system is composed of two groups each comprising an uninterruptible power supply. Referring to FIG. 2, an uninterruptible power supply system according to the present invention is shown. The inventive uninterruptible power supply system 2 includes a first uninterruptible power supply 21 and a second uninterruptible power supply 22, wherein an input voltage Vin is connected to the power input terminal 21a of the first uninterruptible power supply 21 and the power input terminal 22a of the second uninterruptible power supply 22, and the output terminal 21b of the first uninterruptible power supply 21 and the power output terminal 22b of the second uninterruptible power supply 22 are connected to a load 23.

In addition, the first uninterruptible power supply 21 includes an AC/DC converter 211, a DC bus 211d, a charger circuit 212, a battery module 213, a DC/DC converter 214, an inverter 215, a controller 216, a switch circuit 217, a bypass route 218, a communication port 219, and a switch controller 210, wherein the switch circuit 217 includes a first switch S1a and a second switch S2a. Likewise, the second uninterruptible power supply 22 includes an AC/DC converter 221, a DC bus 221d, a charger circuit 222, a battery module 223, a DC/DC converter 224, an inverter 225, a controller 226, a switch circuit 227, a bypass route 228, a communication port 229, and a switch controller 220, wherein the switch circuit 227 includes a first switch S1b and a second switch S2b. The communication port 219 of the first uninterruptible power supply 21 is connected to the communication port 229 of the second uninterruptible power supply 22. The function and association of the elements of the uninterruptible power supply system 2 and the controlling method for the uninterruptible power supply system 2 are described as follows.

In the present embodiment, the power input terminal 21a of the first uninterruptible power supply 21 is used to receive an input voltage Vin, which is termed as a first AC voltage. The AC/DC converter 211 is connected between the power input terminal 21a and the DC bus 211d for converting the input voltage Vin into a DC voltage having a predetermined voltage level. The charger circuit 212 is connected between the DC bus 211d and the battery module 213 for converting the DC voltage outputted from the AC/DC converter 211 into a DC voltage tailored to charge the battery module 213, thereby charging the battery module 213. The DC/DC converter 214 is connected between the battery module 213 and the DC bus 211d for converting the voltage of the battery module 213 into a DC voltage requested by the inverter 215. The inverter 215 is connected between the DC bus 211d and the switch circuit 217 for converting the DC voltage of the DC bus 211d into a standard and reliable output voltage V1, which is termed as a second AC voltage. The switch circuit 217 is connected to the bypass route 218, the inverter 215 and the power output terminal 21b, and can be implemented by for example a silicon-controlled rectifier (SCR), a triode AC switch (TRIAC), an insulated gate bipolar transistor (IGBT), a MOSFET, a relay or a programmable unijunction transistor (PUT). In the present embodiment, the first switch S1a and the second switch S2a of the switch circuit 217 are composed of two silicon-controlled rectifiers being inversely connected in parallel with each other. The bypass route 218 is connected between the switch circuit 217 and the power input terminal 21a. The controller 216 is connected to the power input terminal 21a, the AC/DC converter 211, the charger circuit 212, the DC/DC converter 214, the inverter 215, and the communication port 219 for controlling the operation of the first uninterruptible power supply 21. The switch controller 210 is connected to the switch circuit 217, the power input terminal 21a, the output of the inverter 215 and the communication port 219 for controlling ON/OFF operations of the first switch S1a and the second switch S2a of the switch circuit 217. The function and association of the elements of the second uninterruptible power supply 22 are similar to the function and association of the elements of the first uninterruptible power supply 21, and it is not intended to give details herein.

The controlling method for the uninterruptible power supply system 2 can be applied to control a plurality of uninterruptible power supplies, wherein the uninterruptible power supplies can be divided into a plurality of groups. The controlling method is carried out by examining each uninterruptible power supply group. In the following, two uninterruptible power supply groups each comprising an uninterruptible power supply are to be taken as an example to illustrate the inventive controlling method.

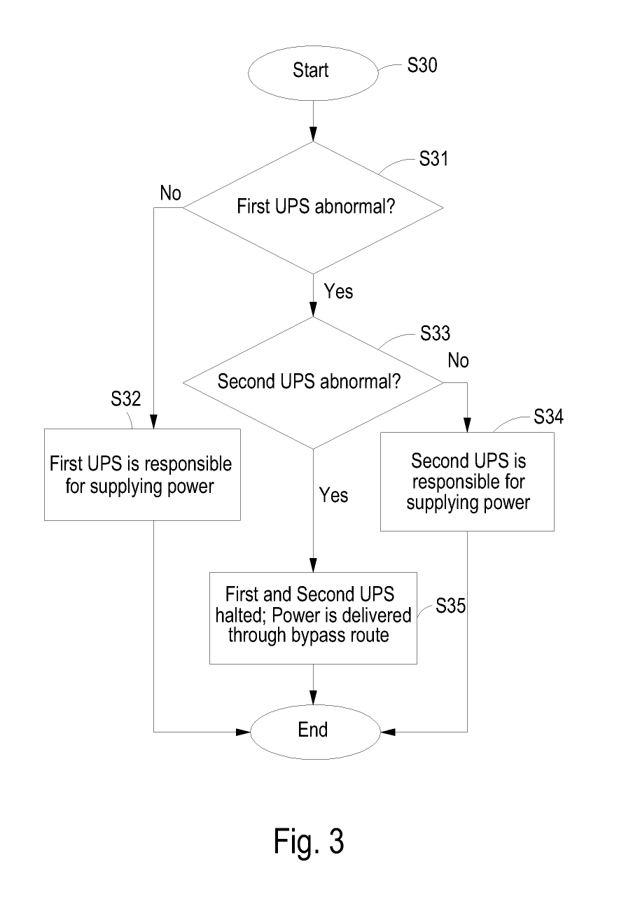

Referring to FIG. 2 and FIG. 3, wherein FIG. 3 is a flowchart illustrating the procedural steps involved in the controlling method of the present invention. As shown in FIG. 3, the controlling method of the present invention is described as follows.

Step S30: Start the controlling procedure of the uninterruptible power supply system;

Step S31: Determining if each uninterruptible power supply of the first uninterruptible power supply group is normal. In the present embodiment, the first uninterruptible power supply group has only one uninterruptible power supply, and thus it is necessary to determine if the first uninterruptible power supply 21 is normal. If it is determined that the first uninterruptible power supply 21 is normal, the method continues with step S32. Otherwise, the method continues with step S33;

Step S32: The load 23 is powered by the first uninterruptible power supply group. In the present embodiment, the first uninterruptible power supply group has only one uninterruptible power supply, and thus the load 23 is powered by the first uninterruptible power supply 21, and the execution of the method is terminated at this step;

Step S33: Determining if the next uninterruptible power supply group is normal. In the present embodiment, the next uninterruptible power supply group is the second uninterruptible power supply group, and the second uninterruptible power supply group is composed of the second uninterruptible power supply 22 only. Hence, it is necessary to determine if the second uninterruptible power supply 22 is normal. If it is determined that the second uninterruptible power supply 22 is normal, the method continues with step S34. Otherwise, the method continues with step S35;

Step S34: The load 23 is powered by the next uninterruptible power supply group. In the present embodiment, the next uninterruptible power supply group is the second uninterruptible power supply group that is composed of the second uninterruptible power supply 22 only. Hence, the load 23 is powered by the second uninterruptible power supply 22, and the execution of the method is terminated at this step;

Step S35: All of the uninterruptible power supply groups halt their operation and power is delivered to the load through bypass routes: In the present embodiment, if both the first uninterruptible power supply group and the second uninterruptible power supply group are abnormal, it indicates that every uninterruptible power supply group are abnormal. In order to avoid the situation that all of the uninterruptible power supply groups are abnormal and the power delivered to the load 23 is interrupted, all of the uninterruptible power supply groups halt their operation and power is delivered to the load 23 through the bypass routes. The execution of the method is terminated at this step.

If the number of the uninterruptible power supply group is more than two, before step S35 the method further includes the following step: Determining if all of the uninterruptible power supply groups have been checked.

If yes, the method continues with step S35. Otherwise, the method jumps back to step S33 to determine if the next uninterruptible power supply group is normal. Because the above-mentioned control flow is executed repetitively, the uninterruptible power supply system 2 can power the load with stability.

Generally speaking, the input voltage Vin would encounter other abnormalities than interruption. These abnormalities includes: (1) The peak voltage of the input voltage Vin increases or decreases by a predetermined percentage of the rated peak voltage, for example, ±10%. (2) The frequency of the input voltage Vin increases or decreases by a predetermined percentage of the rated frequency, for example, ±5%. No matter whether the input voltage encounters abnormality or not, the inverters 215, 225 of uninterruptible power supplies 21, 22 will output a standard and reliable AC voltage to the switch circuits 217, 227. However, if the uninterruptible power supplies 21, 22 encounter abnormality, the inverters 215, 225 of uninterruptible power supplies 21, 22 will output an abnormal voltage to the switch circuits 217, 227 of the uninterruptible power supplies 21, 22. Under this condition, the switch controllers 210, 220 will detect that the uninterruptible power supplies 21, 22 are abnormal. The switch circuits 217, 227 of the uninterruptible power supplies 21, 22 will be manipulated according to the procedure of the controlling method according to the present invention, wherein the switch controllers 210, 220 are communicated with each other by the communication ports 219, 229.

TABLE 1
The ON/OFF status of the switches of the uninterruptible
power supply system

| The first UPS 21 | The second UPS 22 | S1a | S2a | S1b | S2b |
|---|---|---|---|---|---|
| Normal | — | OFF | ON | OFF | OFF |
| Abnormal | Normal | OFF | OFF | OFF | ON |
| Abnormal | Abnormal | ON | OFF | ON | OFF |

Referring to Table. 1, the ON/OFF status of the switches of the uninterruptible power supply system is shown. As indicated in Table. 1, when the first uninterruptible power supply 21 is normal, the load 23 is powered by the first uninterruptible power supply 21. Under this condition, the first switch S1a and the second switch S2a of the switch circuit 217 of the first uninterruptible power supply 21 are OFF and ON respectively, and the first switch S1b and the second switch S2b of the switch circuit 227 of the second uninterruptible power supply 22 are both OFF. When the first uninterruptible power supply 21 is abnormal and the second uninterruptible power supply 22 is normal, the load is powered by the second uninterruptible power supply 22. Under this condition, the first switch S1a and the second switch S2a of the switch circuit 217 of the first uninterruptible power supply 21 are both OFF, and the first switch S1b and the second switch S2b of the switch circuit 227 of the second uninterruptible power supply 22 are OFF and ON respectively. When the first uninterruptible power supply 21 and the second uninterruptible power supply 22 are both normal, it indicates that all of the uninterruptible power supplies are abnormal. Under this condition, the load 23 is powered by the input voltage Vin through the bypass routes of the first uninterruptible power supply 21 and the second uninterruptible power supply 22. Under this condition. the first switch S1a and the second switch S2a of the switch circuit 217 of the first uninterruptible power supply 21 are ON and OFF respectively, and the first switch S1b and the second switch S2b of the switch circuit 227 of the second uninterruptible power supply 22 are ON and OFF respectively.

In addition, the controllers 216, 226 of the uninterruptible power supplies 21, 22 can communicate with each other through the communication ports 219, 229. Furthermore, the output voltages of the uninterruptible power supplies 21, 22 are allowed to have the same voltage level, frequency and phase with each other. In the present embodiment, the output voltage Vo1 of the first uninterruptible power supplies 21 has the same voltage level, frequency and phase with the output voltage Vo2 of the second uninterruptible power supplies 22.

In conclusion, the uninterruptible power supply system and the controlling method thereof according to the present invention uses the switch circuit within the uninterruptible power supplies to manipulate the desired uninterruptible power supply to power the load, so that the uninterruptible power supply system according to the present invention does not need to pass through two switch circuits when delivering power, thereby reducing power loss and enhancing power utilization. In this way, the utility fee can be lowered. In addition, the power delivery route of the uninterruptible power supply system according to the present invention does not include the system static transfer switch, and thus the reliability of the uninterruptible power supply system according to the present invention is heightened. Moreover, the uninterruptible power supply system according to the present invention does not need an additional phase lock loop and can use the controller within the uninterruptible power supply to allow the output voltages of the uninterruptible power supplies to have the same phase with each other. Thus, the cost of the uninterruptible power supply system can be lowered.

While the present invention has been described in terms of what are presently considered to be the most practical and preferred embodiments, it is to be understood that the present invention need not to be restricted to the disclosed embodiment. On the contrary, it is intended to cover various modifications and similar arrangements included within the spirit and scope of the appended claims which are to be accorded with the broadest interpretation so as to encompass all such modifications and similar structures. Therefore, the above description and illustration should not be taken as limiting the scope of the present invention which is defined by the appended claims.

What is claimed is:

1. A controlling method for enabling an uninterruptible power supply system to power a load, wherein the uninterruptible power supply system includes a first uninterruptible power supply and a second uninterruptible power supply, each of the first uninterruptible power supply and the second uninterruptible power supply includes a power input terminal, a power output terminal, a communication port and a bypass route, wherein the power input terminal, the power output terminal and the communication port of the first uninterruptible power supply are respectively connected to the power input terminal, the power output terminal and the communication port of the second uninterruptible power supply, and the power output terminal of the first uninterruptible power supply and the power output terminal of the second uninterruptible power supply are connected to a load, the controlling method comprising the steps of:
(a) determining if the first uninterruptible power supply is normal;
(b) if it is determined that the first uninterruptible power supply is normal, powering the load by the first uninterruptible power supply, and if it is determined that the first uninterruptible power supply is abnormal, determining if the second uninterruptible power supply is normal; and
(c) if it is determined that the second uninterruptible power supply is normal, powering the load by the second uninterruptible power supply, and if it is determined that the second uninterruptible power supply is abnormal, powering the load within an input voltage applied to the first uninterruptible power supply and the second uninterruptible power supply through the bypass route of the first uninterruptible power supply and the bypass route of the second uninterruptible power supply.

2. The controlling method according to claim 1 wherein each of the first uninterruptible power supply and the second uninterruptible power supply further includes a switch circuit connected with the power output terminal, the bypass route and an inverter.

3. The controlling method according to claim 2 wherein the switch circuit includes a first switch and a second switch.

4. The controlling method according to claim 3 wherein each of the first switch and the second switch is at least one selected from a group consisting of a silicon-controlled rectifier, a triode AC switch, an insulated gate bipolar transistor, a MOSFET, a relay and a programmable unijunction transistor.

5. The controlling method according to claim 3 wherein each of the first uninterruptible power supply and the second uninterruptible power supply includes a switch controller connected to the switch circuit, the bypass route, the inverter and the communication port for controlling ON/OFF operations of the first switch and the second switch.

6. The controlling method according to claim 2 wherein the voltage level, frequency and phase of the output voltage of the inverter of the first uninterruptible power supply are similar to those of the output voltage of the inverter of the second uninterruptible power supply.

7. The controlling method according to claim 2 wherein the abnormality of the first uninterruptible power supply and the second uninterruptible power supply is determined by detecting if the peak voltage of the output voltage of the inverter of the uninterruptible power supply increases or decreases by a predetermined percentage of a rated peak voltage, and the predetermined percentage is substantially ±10%.

8. The controlling method according to claim 2 wherein the abnormality of the first uninterruptible power supply and the second uninterruptible power supply is determined by detecting if the frequency of the output voltage of the inverter of the uninterruptible power supply increases or decreases by a predetermined percentage of a rated frequency, and the predetermined percentage is substantially ±5%.

9. A controlling method for enabling an uninterruptible power supply system to power a load, wherein the uninterruptible power supply system includes a plurality of uninterruptible power supplies that are divided into a plurality of groups including at least a first uninterruptible power supply group and a second uninterruptible power supply group, each of the uninterruptible power supplies includes a power input terminal, a power output terminal, a communication port and a bypass route, wherein the power input terminal, the power output terminal and the communication port of the plurality of uninterruptible power supplies are respectively connected with each other, and the power output terminals of the plurality of uninterruptible power supplies are connected to a load, the controlling method comprising the steps of:
(a) determining if each uninterruptible power supply of the first uninterruptible power supply group is normal;
(b) if it is determined that each uninterruptible power supply of the first uninterruptible power supply group is normal, powering the load by the first uninterruptible power supply group, and if it is determined that at least one uninterruptible power supply of the first uninterruptible power supply group is abnormal, determining if each uninterruptible power supply of the next uninterruptible power supply group is normal;
(c) if it is determined that each uninterruptible power supply of the next uninterruptible power supply group is normal, powering the load by the next uninterruptible power supply group, and if it is determined that at least one uninterruptible power supply of the next uninterruptible power supply group is abnormal, determining if all of uninterruptible power supply groups have been checked; and
(d) if all of the uninterruptible power supply groups have been checked, powering the load within an input voltage applied to the plurality of uninterruptible power supplies through the bypass routes of the plurality of uninterruptible power supplies.

10. The controlling method according to claim 9 wherein the step (d) further comprises the step of:
if only a portion of the plurality of uninterruptible power supply groups have not been checked, continuing determining if each uninterruptible power supply of the next uninterruptible power supply group is normal.

11. An uninterruptible power supply system for powering a load, including a first uninterruptible power supply and a second uninterruptible power supply, each of the first and the second uninterruptible power supplies includes:
a battery module for storing power;
an AC/DC converter for storing a first AC voltage from a power input terminal and converting the first AC voltage into a DC voltage;
a charger circuit connected to the AC/DC converter and the battery module for charging the battery module;
an inverter connected to the AC/DC converter and the charger circuit for converting the DC voltage into a second AC voltage;
a bypass route connected to the power input terminal;
a switch circuit connected to the bypass route, the inverter and a power output terminal;
a controller connected to the power input terminal, the AC/DC converter, the charger circuit and the inverter for controlling the operation of the uninterruptible power supply;
a communication port connected to the controller; and
a switch controller connected to the switch circuit, the bypass route and the inverter for enabling the uninterruptible power supply system to performing the following control method of:
(a) determining if the first uninterruptible power supply is normal;
(b) if it is determined that the first uninterruptible power supply is normal, powering the load by the first uninterruptible power supply, and if it is determined that the first uninterruptible power supply is abnormal, determining if the second uninterruptible power supply is normal; and
(c) if it is determined that the second uninterruptible power supply is normal, powering the load by the second uninterruptible power supply, and if it is determined that the second uninterruptible power supply is abnormal, powering the load within an input voltage applied to the first uninterruptible power supply and the second uninterruptible power supply through the bypass route of the first uninterruptible power supply and the bypass route of the second uninterruptible power supply;
wherein the power input terminal, the power output terminal and the communication port of the first uninterruptible power supply are respectively connected to the power input terminal, the power output terminal and the communication port of the second uninterruptible power supply.

12. The uninterruptible power supply system according to claim 11 wherein the switch circuit includes a first switch and a second switch.

13. The uninterruptible power supply system according to claim 12 wherein each of the first switch and the second switch is at least one selected from a group consisting of a silicon-controlled rectifier, a triode AC switch, an insulated gate bipolar transistor, a MOSFET, a relay and a programmable unijunction transistor.

14. The uninterruptible power supply system according to claim 12 wherein the switch controller controls ON/OFF operations of the first switch and the second switch.

15. The uninterruptible power supply system according to claim 11 wherein the voltage level, frequency and phase of the output voltage of the inverter of the first uninterruptible power supply are similar to those of the output voltage of the inverter of the second uninterruptible power supply.

16. The uninterruptible power supply system according to claim 11 wherein the abnormality of each uninterruptible power supply is determined by detecting if the peak voltage of the output voltage of the inverter of the uninterruptible power supply increases or decreases by a predetermined percentage of a rated peak voltage, and the predetermined percentage is substantially ±10%.

17. The uninterruptible power supply system according to claim 11 wherein the abnormality of each uninterruptible power supply is determined by detecting if the frequency of the output voltage of the inverter of the uninterruptible power supply increases or decreases by a predetermined percentage of a rated frequency, and the predetermined percentage is substantially ±5%.

18. The uninterruptible power supply system according to claim 11 wherein each uninterruptible power supply includes a DC/DC converter connected to the battery module, the controller and the inverter for converting the voltage of the battery module into a voltage requested by the inverter.

19. The uninterruptible power supply system according to claim 11 wherein the first AC voltage is a commercially available AC voltage.

20. The uninterruptible power supply system according to claim 11 wherein when the first AC voltage is normal and the battery module has an insufficient capacity, the charger circuit converts the DC voltage into a DC voltage tailored to charge the battery module, thereby charging the battery module.
